(19) United States
(12) Patent Application Publication
(10) Pub. No.: US 2007/0006597 A1
(43) Pub. Date: Jan. 11, 2007

(54) Cryogenic tank system

(76) Inventors: Jalal Hunain Zia, Grand Island, NY (US); Nancy Jean Lynch, North Tonawanda, NY (US); John Henri Royal, Grand Island, NY (US); Thurman Gordon, Amherst, NY (US); Richard John Jibb, Amherst, NY (US); Barry Alan Minbiole, East Amherst, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/174,602

(22) Filed: Jul. 6, 2005

(51) Int. Cl. F17C 3/10; F25B 19/00; F17C 9/02

(52) U.S. Cl. 62/48.2; 62/51.1

(57) ABSTRACT

A cryogenic tank system wherein cryogenic liquid from a primary cryogenic liquid storage tank is subcooled by refrigeration generated by a cryocooler, passed into an auxiliary tank, pressurized, and returned to the primary storage tank, preferably by way of the cryocooler, thus cooling the storage tank contents and reducing the pressure within and the vapor losses from the storage tank.

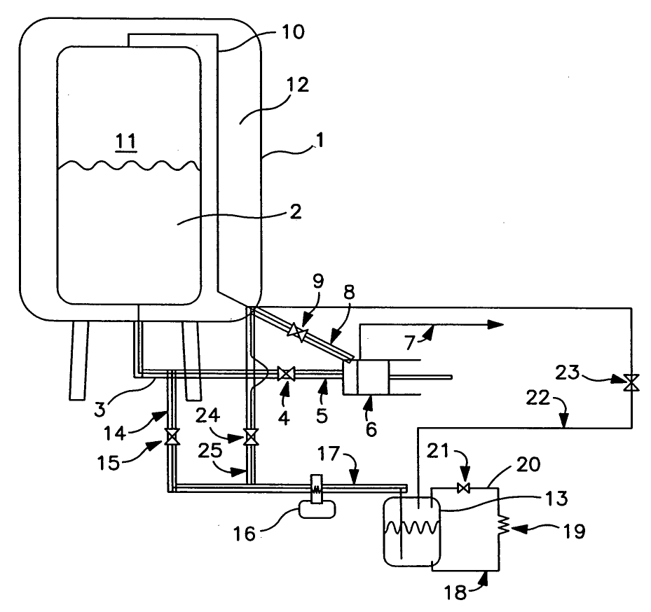

### TECHNICAL FIELD

This invention relates generally to tank systems for the containment and the dispensing of cryogenic liquids.

### BACKGROUND ART

The storage or other containment of a cryogenic liquid involves the use of an insulated vessel or tank to reduce as much as possible the loss of some of the cryogen due to heat leak into the vessel. However, even with the use of the best insulation systems available, a significant portion of the contained cryogen will vaporize due to heat leak and will be vented through control, vent or safety valves. Considering the system operation while dispensing, liquid cryogen may also be lost due to vaporization from pump or line heat leak and from pump priming losses or transfer and filling losses. This loss of liquid cryogen results in a significant economic loss.

### SUMMARY OF THE INVENTION

One aspect of the invention is:

A cryogenic tank apparatus comprising:

(A) a primary tank, a cryocooler, and means for passing liquid cryogen from the primary tank to the cryocooler;

(B) an auxiliary tank and means for passing liquid cryogen from the cryocooler into the auxiliary tank;

(C) means for pressurizing the liquid cryogen passed into the auxiliary tank; and

(D) means for passing the resulting pressurized liquid cryogen into the primary tank.

Another aspect of the invention is:

A method for operating a cryogenic tank system comprising:

(A) withdrawing liquid cryogen from a primary tank and subcooling the withdrawn liquid cryogen;

(B) passing the subcooled liquid cryogen into an auxiliary tank;

(C) pressurizing the subcooled liquid cryogen; and

(D) passing the pressurized liquid cryogen into the primary tank.

As used herein the term “cryocooler” means a refrigerator which can produce refrigeration below 240 K.

As used herein the terms “cryogenic liquid” and “liquid cryogen” mean a fluid which at atmospheric pressure is a gas at a temperature of 240 K.

As used herein the term “subcooling” means cooling a liquid to be at a temperature lower than the saturation temperature of that liquid for the existing pressure.

As used herein the terms “upper portion” and “lower portion” mean these sections of the primary tank respectively above and below the mid point of the tank.

### BRIEF DESCRIPTION OF THE DRAWING

The sole FIGURE is a schematic representation of one preferred embodiment of the cryogenic tank system of this invention.

### DETAILED DESCRIPTION

The invention will be described in detail with reference to the Drawing. Referring now to the FIGURE, insulated vessel or primary tank 1 comprises storage space 11 and insulated space 12. Storage space 11 contains cryogenic liquid 2, typically at a pressure generally within the range of from 0 to 600 pounds per square inch gauge (psig). Among the cryogenic liquids which can be processed with the use of this invention one can name hydrogen, helium, neon, oxygen, nitrogen, argon, carbon dioxide, methane and mixtures such as air and natural gas.

Liquid cryogen is withdrawn from primary tank 1 in conduit 3 and passed through valve 4 and conduit 5 to pump 6. The liquid cryogen is pumped from pump 6 in line 7 to a liquid use point or to a vaporizer for vaporization prior to being passed to a vapor use point. Examples of use points include high pressure cylinder filling, liquid cylinder filling, dewar filling, gas sampling and analysis, and trailer transfilling.

Due to the fact that the pump is generally warmer than the cryogen, some of the liquid cryogen is vaporized in the course of being processed through pump 6. This vaporized fluid is passed from pump 6 in line 8 through valve 9 and then in line 1b into the upper portion of the storage space 11 which contains vapor. Preferably, as illustrated in the FIGURE, vapor return line 10 passes through insulted space or volume 12 from the lower portion to the upper portion of tank 1 prior to communicating with the upper portion of storage space 11.

Auxiliary tank 13 is initially at a pressure less than that of primary tank 1. Some liquid cryogen is passed from primary tank 1 in line 14 through valve 15 to cryocooler 16 wherein it is subcooled by from 1 K to 100 K relative to the pressure in primary tank 1.

Any suitable cryocooler may be used in the practice of this invention. Among such cryocoolers one can name Stirling cryocoolers, Gifford-McMahon cryocoolers and pulse tube refrigerators. Other cooling systems, such as a liquid nitrogen heat exchanger, may also be used. A pulse tube refrigerator is a closed refrigeration system that oscillates a working gas in a closed cycle and in so doing transfers a heat load from a cold section to a hot section. The frequency and phasing of the oscillations is determined by the configuration of the system. The driver or pressure wave generator may be a piston or some other mechanical compression device, or an acoustic or thermoacoustic wave generation device, or any other suitable device for providing a pulse or compression wave to a working gas. That is, the pressure wave generator delivers energy to the working gas within the pulse tube causing pressure and velocity oscillations. Helium is the preferred working gas; however any effective working gas may be used in the pulse tube refrigerator and among such one can name nitrogen, oxygen, argon, xenon and neon or mixtures containing one or more thereof such as air.

The oscillating working gas is preferably cooled in an aftercooler and then in a regenerator as it moves toward the cold end. The geometry and pulsing configuration of the pulse tube refrigeration system is such that the oscillating working gas in the cold head expands for some fraction of the pulsing cycle and heat is absorbed by the working gas by indirect heat exchange which provides refrigeration to the liquid cryogen for the subcooling. Preferably the pulse tube refrigeration system employs an inertance tube and reservoir to maintain the gas displacement and pressure pulses in appropriate phases. The size of the reservoir is sufficiently large so that essentially very little pressure oscillation occurs in it during the oscillating flow.

The subcooled liquid cryogen is passed from cryocooler 16 in line 17 into auxiliary tank 13. This subcooled liquid cryogen is then pressurized to be at a pressure greater than that of primary tank 1 and generally to be at a pressure within the range of from 20 to 620 psig. Preferably this pressurization takes place within auxiliary tank 13. The FIGURE illustrates one preferred means for carrying out this pressurization using a pressure building circuit wherein subcooled liquid cryogen is passed in line 18 to pressure building coil 19 wherein it is heated and vaporized. The vaporized cryogen is then passed in line 20 through valve 21 and back into auxiliary tank 13 wherein the volume expansion resulting from the vaporization serves to increase the pressure within auxiliary tank 13. Another means for increasing the pressure of the subcooled cryogenic liquid is by use of a liquid pump, such as a submersible liquid pump positioned within auxiliary tank 13, or by pump 6 using a piping and valving arrangement which is not shown. Other means for increasing the pressure of the subcooled cryogenic liquid in the auxiliary tank include introducing compatible vapors into the tank at appropriate pressures from external sources.

As the pressure of the subcooled liquid cryogen increases to be above the pressure within the primary tank, liquid flow is reversed from auxiliary tank 13 in line 17 through cryocooler 16 and valve 15 and in lines 14 and 3 into the lower portion of primary tank 1 which contains liquid. This liquid cryogen flow reversal serves to keep the contents of primary tank colder than they would otherwise be, thus keeping the pressure lower and resulting in lesser vapor loss from primary tank 1. The liquid flow reversal through the cryocooler also serves to cool down the liquid further, thus enhancing the efficiencies of the system. Optionally the subcooled liquid cryogen may flow from auxiliary tank 13 to the lower portion of primary tank 1 while bypassing the cryocooler 16. Vapor from auxiliary tank 13 is passed out from tank 13 in line 22 through valve 23 and then into vapor return line 10 for passage into the upper portion of primary tank 1. When the outflow of fluids from auxiliary tank 13 causes the pressure within the auxiliary tank to fall below that at the bottom of the primary tank, the cryogenic liquid flow is again reversed and the cryogenic liquid flows from primary tank 1 into auxiliary tank 13 as was previously described.

The embodiment of the invention illustrated in the FIGURE is a particularly preferred embodiment wherein pressurized subcooled liquid cryogen may be passed into the upper portion of the primary tank which contains vapor. In this mode valve 24 is opened and some pressurized subcooled liquid cryogen is passed from auxiliary tank 13 in line 17 through cryocooler 16, and then in line 25 through valve 24 to return line 10. The pressurized subcooled liquid cryogen is then passed in line 10 to and into the upper portion of primary tank 1. The introduction of the subcooled liquid cryogen into the upper portion of the primary tank serves to condense some of the vapor in this space. This results in a pressure reduction within the storage space of the primary tank which further lowers the potential for vapor loss from the primary tank.

Although the invention has been described in detail with reference to a particularly preferred embodiment, those skilled in the art will understand that there are other embodiments of the invention within the spirit and the scope of the claims. For example, the invention may be practiced with more than one primary tank and/or more than one auxiliary tank.

1. A cryogenic tank apparatus comprising:
(A) a primary tank, a cryocooler, and means for passing liquid cryogen from the primary tank to the cryocooler;
(B) an auxiliary tank and means for passing liquid cryogen from the cryocooler into the auxiliary tank;
(C) means for pressurizing the liquid cryogen passed into the auxiliary tank; and
(D) means for passing the resulting pressurized liquid cryogen into the primary tank.

2. The apparatus of claim 1 wherein the means for passing pressurized liquid cryogen into the primary tank includes the cryocooler.

3. The apparatus of claim 1 wherein the means for passing pressurized liquid cryogen into the primary tank communicates with the lower portion of the primary tank.

4. The apparatus of claim 1 wherein the means for passing pressurized liquid cryogen into the primary tank communicates with the upper portion of the primary tank.

5. The apparatus of claim 1 further comprising means for passing vapor from the auxiliary tank to the primary tank.

6. The apparatus of claim 1 wherein the means for pressurizing the liquid cryogen comprises a pressure building coil.

7. The apparatus of claim 1 wherein the means for pressurizing the liquid cryogen comprises a liquid pump.

8. The apparatus of claim 1 wherein the cryocooler is a pulse tube refrigerator.

9. A method for operating a cryogenic tank system comprising:
(A) withdrawing liquid cryogen from a primary tank and subcooling the withdrawn liquid cryogen;
(B) passing the subcooled liquid cryogen into an auxiliary tank;
(C) pressurizing the subcooled liquid cryogen; and
(D) passing the pressurized liquid cryogen into the primary tank.

10. The method of claim 9 wherein the subcooled liquid cryogen is pressurized while in the auxiliary tank.

11. The method of claim 9 wherein the pressurized liquid cryogen is still subcooled when it is passed into the primary tank.

12. The method of claim 9 wherein the pressurized liquid cryogen is passed into the primary tank in the lower portion of the primary tank.

13. The method of claim 9 wherein the pressurized liquid cryogen is passed into the primary tank in the upper portion of the primary tank.

14. The method of claim 9 wherein some of the subcooled liquid cryogen passed into the auxiliary tank is vaporized, and the resulting vapor is passed into the primary tank.
